(19) United States
(12) Patent Application Publication
(10) Pub. No.: US 2013/0096077 A1
(43) Pub. Date: Apr. 18, 2013

(54) Nematicidal Mixtures for Use in Sugar Cane

(71) Applicants: Alexander Guttenkunst Prade, Sao Bernardo do Campo (BR); Antonio Cesar Azenha, Ribeirao Preto (BR)

(72) Inventors: Alexander Guttenkunst Prade, Sao Bernardo do Campo (BR); Antonio Cesar Azenha, Ribeirao Preto (BR)

(73) Assignee: BASF SE, Ludwigshafen (DE)

(21) Appl. No.: 13/805,546

(22) PCT Filed: Jun. 21, 2011
(86) PCT No.: PCT/EP2011/060274

§ 371 Date: Dec. 19, 2012

Related U.S. Application Data
(60) Provisional application No. 61/357,545, filed on Jun. 23, 2010.

(30) Foreign Application Priority Data
Jun. 23, 2010 (EP) 10166976.0

(51) Int. Cl. A01N 43/90; A01N 47/02

(52) U.S. Cl. CPC A01N 43/90; A01N 47/02
USPC 514/30

(57) ABSTRACT

A method for the synergistic plant nematode control in sugar cane with a mixture of fipronil and abamectin comprising fipronil and abamectin in a ratio by weight of from 1:10 to 10:1, wherein the mixture is applied to sugar cane in furrow, a method for the synergistic plant nematode control in sugar cane with a mixture of fipronil and abamectin comprising fipronil and abamectin in a ratio by weight of from 1:10 to 10:1, wherein the mixture is applied to plant propagation materials of sugar cane, and a method which combines synergistic plant nematode control with (preferably synergistic) improvement of the plant health of sugar cane plants.

The present invention relates to a method for the synergistic plant nematode control in sugar cane with a mixture of fipronil and abamectin comprising fipronil and abamectin in a ratio by weight of from 1:10 to 10:1, wherein the mixture is applied to sugar cane in furrow.

Also, the present invention relates to a method for the synergistic plant nematode control in sugar cane with a mixture of fipronil and abamectin comprising fipronil and abamectin in a ratio by weight of from 1:10 to 10:1, wherein the mixture is applied to plant propagation materials of sugar cane.

Additionally, the present invention provides a method which combines synergistic plant nematode control with (preferably synergistic) improvement of the plant health of sugar cane plants (as defined below).

Additionally, the present invention provides a method which combines synergistic protection of plant propagation material of sugar cane from harmful plant nematodes with (preferably synergistic) improvement of the plant health of sugar cane plants (as defined below).

The term “plant propagation material” is to be understood to denote all the generative parts of the sugar cane plant such as seeds and vegetative plant material such as cuttings, which can be used for the multiplication of the plant. This includes seeds, roots, shoots, sprouts and other parts of plants, including seedlings and young plants, which are to be transplanted after germination or after emergence from soil. These young plants may also be protected before trans-plantation by a total or partial treatment by immersion or pouring.

One typical problem arising in the field of nematode control in sugar cane lies in the need to reduce the dosage rates of the active ingredient(s) in order to reduce or avoid unfavorable environmental or toxicological effects whilst still allowing effective plant nematode control.

Another difficulty in relation to the use of plant nematicides is that the repeated and exclusive application of an individual plant nematicidal compound leads in many cases to a rapid selection of plant nematodes which have developed natural or adapted resistance against the active compound in question. Therefore there is a need for pest control agents that help prevent or overcome plant nematode resistance in sugar cane.

Another problem underlying the present invention is the desire for methods that improve sugar cane plants, a process which is generally and commonly and hereinafter referred to as “plant health”.

The term plant health generally comprises various sorts of improvements of plants that are not connected to the control of pests. For example, advantageous properties that may be mentioned are improved crop characteristics including: emergence, crop yields, protein content, oil content, starch content, more developed root system, improved root growth, improved root size maintenance, improved root effectiveness, improved stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination.

With regard to the use according to the present invention, improved plant health preferably refers to improved sugar cane characteristics including: crop yield, more developed root system (improved root growth), improved root size maintenance, improved root effectiveness, tillering increase, increase in plant height, bigger leaf blade, less dead basal leaves, stronger tillers, greener leaf color, photosynthetic activity, more productive tillers, enhanced plant vigor, and increased plant stand.

With regard to the present invention, improved plant health preferably especially refers to improved sugar cane properties selected from crop yield, more developed root system, improved root growth, improved root size maintenance, improved root effectiveness, tillering increase, and increase in plant height.

Most preferably, improved plant health refers to improved sugar cane properties selected from more developed root system, improved root growth, improved root size maintenance, improved root effectiveness, and tillering increase.

It was therefore an object of the present invention to provide a method which provides improved control of plant nematodes in sugar cane while reducing the dosage rate of the plant nematicides, while in parallel improving the plant health and/or enhancing the spectrum of activity and/or to resistance management and/or increasing the yield of sugar cane.

Specifically, it was an object of the present invention to provide a method which provides improved control of plant nematodes in sugar cane, while in parallel improving the plant health of the sugar cane plants.

We have found that these objects are in part or in whole achieved by the inventive method defined at the outset. Moreover, we have found that simultaneous, that is joint or separate, application of fipronil and abamectin or successive application of fipronil and abamectin in a ratio by weight of from 1:10 to 10:1, preferably from 1:5 to 5:1, more preferably from 1:1 to 5:1, allows enhanced control of plant nematodes compared to the control rates that are possible with the individual compounds.

Moreover, we have found that simultaneous, that is joint or separate, application of fipronil and abamectin or successive application of fipronil and abamectin in a ratio by weight of from 1:10 to 10:1 allows enhanced control of plant nematodes compared to the control rates that are possible with the individual compounds and in parallel is suitable for improving the plant health of sugar cane plants when applied to sugar cane plants, parts of sugar cane plants, sugar cane plant propagation materials (preferably segments), or at their locus of growth.

Preferably, such improvement of sugar cane plant health is synergistic.

Moreover, it has been found that the inventive method in addition to synergistic plant nematode control in sugar cane also provides excellent control of termites (Isoptera).

Fipronil and abamectin as well as their pesticidal action and methods for producing them are generally known. For instance, they may be found in The Pesticide Manual, 14th Edition, British Crop Protection Council (2006) among other publications.

The plant nematode activity of abamectin is generally known. However, abamectin has not been used in sugar cane commercially before the filing of the present invention.

Plant nematode control with fipronil has been generally mentioned in, e.g., EP-A 295 117. Results however have not been satisfying with the compound applied alone.

A composition comprising an insecticidal mixture of fipronil plus avermectin in a weight ratio of 1:3 to 2:1 has been disclosed in CN 101133738 for use in crops, particularly in rice against rice leaf rollers.

CN 1265268 discloses the use of granulated product containing a mixture of fipronil and abamectin in ratios of 0.5 to 20, preferably 0.1 to 5, in various crops but not in sugar cane.

In JP 10324605, a mixture of fipronil with abamectin against spider mites is described.

Several documents have described the use of a mixture of fipronil and abamectin for control of parasites in and on animals, such as EP-A 1066854, WO 98/011780 or others.

No mention has been made, however, of the favorable use of the mixture of fipronil and abamectin for treatment of nematodes in sugar cane fields. Moreover, there is no suggestion in the prior art of the plant health improvements, specifically those selected from a more developed root system (improved root growth), root size maintenance, root effectiveness, and tillering increase of the mixture for the particular use in sugar cane, which is described herein for the first time.

Plant health effects of fipronil in general have been described in EP-A 822 746. The increase in sugar content in sugar cane by treatment with fipronil has been disclosed in U.S. Pat. No. 5,981,554. WO08/59054 describes the use of fipronil to increase the dry biomass in plants such as soybean and sugar cane. WO 09/24546 teaches yield increase by treatment with fipronil for crops growing in a medium with suboptimal nitrogen content with a focus on wheat.

Plant health effects of abamectin in sugar cane have not been described.

Besides, the inventive use of the mixture of fipronil and abamectin provides for a significant higher yield of sugar cane when compared to the use of the single compounds.

The inventive method is especially useful for the control of plant nematode species selected from Meloidogyne species (such as Meloidogyne incognita, Meloidogyne javanica), Heterodera species (such as Heterodera avenae, Heterodera glycines, Heterodera schachtii, Heterodera trifolil), Ditylenchus species (such as Ditylenchus destructor, Ditylenchus dipsaci), Helicotylenchus species (such as Heliocotylenchus multicinctus), Pratylenchus species (such as Pratylenchus neglectus, Pratylenchus penetrans, Pratylenchus curvitatus, Pratylenchus goodeyi, Pratylenchus brachyurus), Rotylenchus species (such as Rotylenchus robustus), and Paratrichodorus species.

Specifically, the inventive method is especially useful for the control of plant nematode species selected from Meloidogyne species (such as Meloidogyne incognita, Meloidogyne javanica), Helicotylenchus species (such as Heliocotylenchus multicinctus), Pratylenchus species (such as Pratylenchus neglectus, Pratylenchus penetrans, Pratylenchus curvitatus, Pratylenchus goodeyi, Pratylenchus brachyurus), and Paratrichodorus species.

The inventive method is especially useful for the control of plant nematode species selected from Helicotylenchus species and Paratrichodorus species.

The inventive method is suitable for any and all developmental stages of nematodes, such as egg, larvae, juvenil, and adult.

The inventive method can be used for application to the soil in furrow and for treatment of plant propagation materials such as sugar cane segments of 1 to 2, preferably 1 node.

Preferably, the mixture is applied to the soil in furrow. Therefore, generally a tank mix formulation is applied in furrow spraying over the sugar cane stems (cuttings/segments), generally of 1 to 3 nodes segments, preferably 2 nodes segments, at the planting time.

In a further embodiment of the invention fipronil and abamectin is applied in combination with further active ingredients, such as fungicides, preferably strobilurines. Preferred strobilurine compounds are selected from kresoxim-methyl, azoxystrobin, metominostrobin, fluoxastrobin, picoxystrobin, dimoxystrobin, pyraclostrobin, trifloxystrobin, orysastrobin, enestroburin, methyl (2-chloro-5-[1-(3-methyl-benzyloxyimino)-ethyl]-benzyl)-carbamic acid ester, methyl (2-chloro-5-[1-(6-methyl-pyridin-2-ylmethoxyimino)-ethyl]-benzyl)-carbamic acid ester, and methyl 2-(ortho((2,5-dimethylphenyl-oxymethylen)phenyl)-3-methoxy-acrylic acid ester. Particularly preferred is pyraclostrobin.

The optional strobilurine compound may be admixed preferably in a ratio of 10:1 to 1:10 to the fipronil-abamectin combination.

Advantageously, the inventive method is used during the planting process and/or after planting. Application of the mixture of fipronil and abamection is preferably done one to three times per season, preferably one to two times, most preferably one time.

The inventive method preferably is used during or shortly after the planting process (this is, accompanying the planting process) by in furrow application of the mixture of fipronil plus abamectin. Generally, sugar cane will be harvested from 5 to 6 times in a season.

The present invention is especially relevant for sugar cane which is harvested according to the ratooning method. Ratooning is a method which leaves the lower parts of the sugar cane plant along with the root uncut at the time of harvesting to give the “ratoon” or the stubble sugar cane plant.

Ratooning in sugar cane may lead to thinner canes with low sugar content. There is also an increased risk of pests and disease. Thus, according to a preferred embodiment of the invention, the in furrow application of the mixture of fipronil and abamectin is repeated during the ratooning phase after the second or third harvest, preferably in areras with high infestation by nematodes.

In another preferred embodiment, the method is used for treatment of plant propagation materials. The term propagation material denotes stem sections of the cane (also known as cane cuttings). The stem of sugar cane comprises generally several nodes, wherein the term “node” means the part of the stem f the plant from which a leaf, branch, or aerial root growths. Suitable materials for cuttings are pieces of cane cut from 8 to 14 month old healthy plants. Typically, the cane is cutted into smaller stem sections having 2 to 3 or more nodes. In WO 02/000401, a method of growing sugar cane from one node stem sections with a length of 2 to 12 cm which have been treated with certain pesticides has been described.

The inventive method can be used for treating stem sections having from 1 to 4 nodes, 1 to 3 nodes, 1 to 2 nodes, and 1 node. When the method is used for treatment of plant propagation materials, the use on stem section having 1 to 3 nodes, 1 to 2 nodes, and 1 node is preferred. Most preferred is the treatment of 1 node stem sections.

For use according to the present invention, the mixtures of fipronil and abamectin, and optionally further active ingredients, can be converted into the customary formulations, for example solutions, emulsions, suspensions, dusts, powders, pastes and granules. The use form depends on the particular intended purpose; in each case, it should ensure a fine and even distribution of the mixtures according to the present invention. The formulations are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical formulations may also comprise auxiliaries which are customary in agrochemical formulations. The auxiliaries used depend on the particular application form and active substance, respectively.

Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for plant propagation material formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wtters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to formulations, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the formulation. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding fipronil and abamectin and, if appropriate, further active substances, with at least one solid carrier.

Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Examples for formulation types are:

1. Composition types for dilution with water

i) Water-soluble concentrates (SL, LS)

10 parts by weight of the mixture of fipronil and abamectin are dissolved in 90 parts by weight of water or in a water-soluble solvent. As an alternative, wetting agents or other auxiliaries are added. The active substance dissolves upon dilution with water. In this way, a formulation having a content of 10% by weight of active substance is obtained.

ii) Dispersible concentrates (DC)

20 parts by weight of the mixture of fipronil and abamectin are dissolved in 70 parts by weight of cyclohexanone with addition of 10 parts by weight of a dispersant, e.g. polyvinylpyrrolidone. Dilution with water gives a dispersion. The active substance content is 20% by weight.

iii) Emulsifiable concentrates (EC)

15 parts by weight of compounds of the mixture of fipronil and abamectin are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

### iv) Emulsions (EW, EO, ES)

25 parts by weight of compounds of the mixture of fipronil and abamectin are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

### v) Suspensions (SC, OD, FS)

In an agitated ball mill, 20 parts by weight of the mixture of fipronil and abamectin are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-dispersible granules and water-soluble granules (WG, SG)

50 parts by weight of compounds of the mixture of fipronil and abamectin are ground finely with addition of 50 parts by weight of dispersants and wetting agents and prepared as waterdispersible or water-soluble granules by means of technical appliances (e.g. extrusion, spray tower, fluidized bed). Dilution with water gives a stable dispersion or solution of the active substance. The composition has an active substance content of 50% by weight.

vii) Water-dispersible powders and water-soluble powders (WP, SP, SS, WS)

75 parts by weight of the mixture of fipronil and abamectin are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of the mixture of fipronil and abamectin are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition types to be applied undiluted
ix) Dustable powders (DP, DS)

5 parts by weight of the mixture of fipronil and abamectin are ground finely and mixed intimately with 95 parts by weight of finely divided kaolin. This gives a dustable composition having an active substance content of 5% by weight.

### x) Granules (GR, FG, GG, MG)

0.5 parts by weight of the mixture of fipronil and abamectin is ground finely and associated with 99.5 parts by weight of carriers. Current methods are extrusion, spray-drying or the fluidized bed. This gives granules to be applied undiluted having an active substance content of 0.5% by weight.

xi) ULV solutions (UL)

10 parts by weight of the mixture of fipronil and abamectin are dissolved in 90 parts by weight of an organic solvent, e.g. xylene. This gives a composition to be applied undiluted having an active substance content of 10% by weight.

The agrochemical formulations generally comprise between 0.01 and 95%, preferably between 0.1 and 90%, most preferably between 0.5 and 90%, by weight of active substances. The mixtures of fipronil and abamectin are employed in a purity of from 90% to 100%, preferably from 95% to 100% (according to NMR spectrum).

The mixtures of fipronil and abamectin can be used as such or in the form of their compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the mixture of fipronil and abamectin.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of the mixture of fipronil and abamectin.

The mixtures of fipronil and abamectin may also be used successfully in the ultra-low-volume process (ULV), it being possible to apply compositions comprising over 95% by weight of active substance, or even to apply the active substance without additives.

Various types of oils, wetters, adjuvants, herbicides, fungicides, other pesticides, or bactericides may be added to the active compounds, if appropriate not until immediately prior to use (tank mix). These agents can be admixed with the mixture of fipronil and abamectin in a weight ratio of 1:100 to 100:1, preferably 1:10 to 10:1.

Compositions of this invention may also contain fertilizers such as ammonium nitrate, urea, potash, and superphosphate, phytotoxicants and plant growth regulators and safeners. These may be used sequentially or in combination with the above-described compositions, if appropriate also added only immediately prior to use (tank mix). For example, the plant(s) may be sprayed with a composition of this invention either before or after being treated with the fertilizers.

Compositions, which are especially useful for plant propagation material treatment are e.g.:

A Soluble concentrates (SL, LS)

### D Emulsions (EW, EO, ES)

### E Suspensions (SC, OD, FS)

F Water-dispersible granules and water-soluble granules (WG, SG)
G Water-dispersible powders and water-soluble powders (WP, SP, WS)

### H Gel-Formulations (GF)

I Dustable powders (DP, DS)

These compositions can be applied to plant propagation materials diluted or undiluted. These compositions can be applied to plant propagation materials diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material are known in the art, and include dressing, coating, pelleting, dusting and soaking application methods of the propagation material (and also in furrow treatment). In a preferred embodiment, the compounds or the compositions thereof, respectively, are applied on to the plant propagation material by a method such that germination is not induced, e.g. by segment dressing, pelleting, coating and dusting.

In the treatment of plant propagation material, the application rates of the inventive mixture are generally for the formulated product (which usually comprises from 10 to 750 g/l of the active(s)).

Sugar cane plants which can be treated with the inventive method include all genetically modified plants or transgenic plants, e.g. plants which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

Fipronil and abamectin according to the inventive method can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare a subject agrochemical composition. E.g., kits may include fipronil and abamection and/or an adjuvant component and/or a further pesticidal compound (e.g. insecticide or fungicide) and/or a growth regulator component). One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The user applies the composition according to the inventive method usually from a predosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquor or the agrochemical composition according to the invention is thus obtained. Usually, 50 to 200 liters of the ready-to-use spray liquor are applied per hectare of agricultural useful area, preferably 100 to 150 liters. According to one embodiment, the individual compounds fipronil and abamectin may be formulated as composition (or formulation) such as parts of a kit or parts of a binary or ternary or quaternary mixture may be mixed by the user himself in a spray tank and further auxiliaries may be added, if appropriate (tank mix), for use according to the inventive method.

In a further embodiment, either the individual compounds fipronil and abamectin of the inventive method may be formulated as composition or partially premixed components, e.g. components comprising fipronil and abamectin may be mixed by the user in a spray tank and further auxiliaries and additives may be added, if appropriate (tank mix).

Fipronil and abamectin according to the inventive method are used in mixing ratios by weight of 1:10 to 10:1. A preferred ratio by weight is fipronil:abamectin=1:1 to 8:1, a more preferred ratio by weight is fipronil:abamectin=1:1 to 6:1, an even more preferred ratio by weight is fipronil:abamectin=2:1 to 6:1, a more preferred ratio by weight is fipronil:abamectin=2.1:1 to 6:1, a more preferred ratio by weight is fipronil:abamectin=2.1:1 to 5:1. Especially preferred ratio by weight is fipronil:abamectin=2.1:1 to 3.0:1. The optional strobilurine compound may be admixed preferably in a ratio of 10:1 to 1:10 to the fipronil-abamectin combination.

Depending on the desired effect, the application rates of the mixtures according to the invention are from 5 g/ha to 2000 g/ha, preferably from 50 to 1500 g/ha, in particular from 50 to 750 g/ha. Most preferred are application rates of 200 to 500 g/ha, preferable from 200 to 400 g/ha.

The separate or joint application of fipronil and abamectin or of the mixtures of fipronil and abamectin is carried out by spraying the seedlings, the plants or the soils before or after sowing of the plants or before or after emergence of the plants.

The synergistic nematicidal and plant health activity of the mixture of fipronil and abamectin in sugar cane can be demonstrated by the experiments below:

### Biological Tests

Fipronil was used in the commercially available formulation Regent® 800 WG, containing Fipronil in a concentration of 800 g/kg. Abamectin was used in the commercially available EC formulation Vertimec® 18 CE, containing Abamectin in a concentration of 18 g/I.

Tank mixes of the commercial formulations of fipronil and abamectin diluted with water were prepared in a ratio such that the application rates identified in the tables below were achieved when 100 liter of tank mix formulation were applied to sugar cane in furrow.

The tank mix formulation was applied in furrow spraying over the sugar cane stems (cuttings/segments, 1 to 3 nodes segments) at the planting time.

The average activity and formulation mixture activity is given in the tables. The synergistic effect was determined by Limpel's formula. Synergism was evident if the observed effect for the mixture is greater than the expected calculated effect:

E=X+Y−X·Y/100

E=Expected activity of the mixture
X=activity of compound X Y=activity of compound Y

### EXAMPLE 1

### Nematicidal Activity

Treatments were done mid of June 2009 in Brazil in sugar cane fields which had not been pretreated with nematicides, that is, in fields showing an average nematode population.

Treatments were done only at the time of planting, that is, no further in furrow treatment was conducted. Each treatment experiment was replicated 6 times.

Nematicidal activity for Helicotylenchus and Paratrichodorus species was evaluated before the spraying for different portions of 1000 ml of soils collected at different sites of the field (“blank” in Table 1).

90 days after spraying the tank mix formulation, different portions of 1000 ml of soil (including roots) were collected at different sites of the field, and the soil and the root knots were evaluated for nematicidal activity of Helicotylenchus and Paratrichodorus species and efficacy/mortality, respectively.

Synergism was evident if the % observed mortality for the mixture was greater than the % expected mortality.

TABLE 1

| | | Nematode activity | | Expected |
|---|---|---|---|---|
| | dose | in the soil 90 | Efficacy/ | mortality |
| Product | [g a.i./ha] | days after planting | mortality | E |
| | | Helicotylenchus species | | |
| blank | — | 317 | — | — |
| Fipronil | 200 | 367 | 0 | — |
| Abamectin | 90 | 117 | 63 | |
| Fipronil + | 200 + 90 | 50 | 84 | 63 |
| Abamectin | | | | |
| | | Paratrichodorus species | | |
| blank | — | 133 | — | — |
| Fipronil | 200 | 100 | 25 | — |
| Abamectin | 90 | 133 | 0 | |
| Fipronil + | 200 + 90 | 17 | 87 | 24 |
| Abamectin | | | | |

The test results show that the inventive method provides a considerable enhanced nematicidal activity demonstrating synergism compared to the calculated sum of the single activities.

### Plant Health Activity

### EXAMPLE 2

### Tillering

The tank mix formulation of the mixture of fipronil and abamectin was prepared as described above for testing of nematicidal activity. The tank mix formulation was applied to sugar cane as described above for testing of nematicidal activity.

Tillering was evaluated before the application of the tank mix (“blank” in Table 2) and 180 days after planting/application the tank mix formulation. Each replication (plot) was evaluated at 3 different randomized points, each point consisting of 1.0 linear meter of the central rows of the plot. Evaluation was done for 4 replications (plots).

The average number of tillers is given in Table 2:

TABLE 2

| | | No. of | | |
|---|---|---|---|---|
| | dose | tillers 180 days | % of | Expected % |
| Product | [g a.i./ha] | after planting | increase | of increase |
| blank | — | 19.75 | 0 | — |
| Fipronil | 200 | 20.25 | 2.5 | — |
| Abamectin | 90 | 21.5 | 8.9 | — |
| Fipronil + Abamectin | 200 + 90 | 23.25 | 17.7 | 11.2 |

The test results show that the inventive method provides a considerable enhanced plant health activity demonstrating synergism compared to the calculated sum of the single activities.

### EXAMPLE 3

### Yield Increase

Treatments were done mid of June in Brazil in sugar cane (variety SP80-1842) fields, with spacing between rows of 150 cm, respectively. The tank mix formulations were applied in furrow spraying over the sugar cane stems (cuttings/segments, 1 to 3 nodes segments) at the planting time. For fertilizing, 500 kg/ha of NPK (04-30-20) was applied. Gamit® herbicide was applied for weed control.

Tank mixes of the commercial formulations of fipronil and abamectin diluted with water were prepared in a ratio such that the application rates identified in Table 3 below were achieved when 300 liter of tank mix formulation were applied to sugar cane in furrow.

Treatments were done only at the time of planting, that is, no further in furrow treatment was conducted. Each treatment experiment was replicated 6 times with 8 rows of plants with 10 m length.

The average activity and formulation mixture activity is given in Table 3.

TABLE 3

| | dose | Yield | % increase | Expected % |
|---|---|---|---|---|
| Product | [g a.i./ha] | [tons/ha] | of yield | increase |
| untreated | — | 102.81 | — | — |
| Fipronil | 200 | 106.31 | 3.4 | — |
| Abamectin | 126 | 106.33 | 3.4 | |
| Fipronil + Abamectin | 200 + 126 | 117.42 | 14.2 | 6.65 |

The test results show that the inventive method provides a considerably enhanced yield demonstrating synergism compared to the calculated sum of the single activities.

1-14. (canceled)

15. A method for the synergistic plant nematode control in sugar cane with a mixture of fipronil and abamectin comprising fipronil and abamectin in a ratio by weight of from 1:10 to 10:1, wherein the mixture is applied to sugar cane in furrow.

16. A method for the synergistic plant nematode control in sugar cane with a mixture of fipronil and abamectin comprising fipronil and abamectin in a ratio by weight of from 1:10 to 10:1, wherein the mixture is applied to plant propagation materials of sugar cane.

17. The method according to claim 15, wherein the plant nematodes are selected from the group consisting of Meloidogyne species, Pratilenchus species, Helicotylencus species, and Paratrichodorus species.

18. The method according to claim 15, wherein the plant health of sugar cane is improved.

19. The method according to claim 15 wherein the plant health of sugar cane is improved synergistically.

20. The method according to claim 15 wherein improved plant health is an improved sugar cane plant property selected from the group consisting of more developed root system, improved root growth, improved root size maintenance, improved root effectiveness, and tillering increase.

21. The method according to claim 15 wherein improved plant health is an improved sugar cane plant property selected from the group consisting of increase of tillering and crop yield.

22. The method according to claim 15 wherein the ratio by weight of fipronil and abamectin is from 1:1 to 5:1.

23. The method according to claim 15 wherein the mixture of fipronil and abamectin is applied for the first time during the planting process and for the second time during the ratooning phase after the second or third harvest.

24. The method according to claim 15, wherein the mixture of fipronil and abamectin is applied during the planting process.

25. The method according to claim 15, wherein the mixture is applied to 1 to 3 node segments of sugar cane.

26. The method according to claim 15, wherein the mixture is applied to 1 node segments of sugar cane.

27. The method according to claim 15, wherein the mixture is applied in an amount of from 200 g/ha to 400 g/ha.

28. A method for the synergistic plant nematode control in sugar cane with fipronil and abamectin comprising furrowapplying fipronil and abamectin simultaneously, that is jointly or separately, or in succession to sugar cane in a ratio by weight of from 1:10 to 10:1.

29. The method according to claim 28, wherein the plant nematodes are selected from the group consisting of Meloidogyne species, Pratilenchus species, Helicotylencus species, and Paratrichodorus species.

30. The method according to claim 28, wherein the plant health of sugar cane is improved.

31. The method according to claim 28 wherein the plant health of sugar cane is improved synergistically.

32. The method according to claim 28 wherein the ratio by weight of fipronil and abamectin is from 1:1 to 5:1.

33. The method according to claim 28, wherein the mixture of fipronil and abamectin is applied during the planting process.

34. The method according to claim 28, wherein the mixture is applied to 1 to 3 node segments of sugar cane.
